(19) United States
(12) Patent Application Publication
(10) Pub. No.: US 2026/0281653 A1
(43) Pub. Date: Sep. 17, 2026

(54) Systems and Methods for Hybrid Spatial Audio

(71) Applicant: SYNG, Inc., Marina del Rey, CA (US)

(72) Inventors: Christos Kyriakakis, Venice, CA (US); Ryan Mihelich, Venice, CA (US)

(73) Assignee: SYNG, Inc., Marina del Rey, CA (US)

(21) Appl. No.: 19/161,936

(22) PCT Filed: Mar. 4, 2024
(86) PCT No.: PCT/US2024/018412

§ 371 Date: Sep. 3, 2025

Related U.S. Application Data
(60) Provisional application No. 63/488,453, filed on Mar. 3, 2023.

(51) Int. Cl. H04S 7/00; H04R 3/12

(52) U.S. Cl. CPC H04S 7/304; H04R 3/12; H04S 2420/01

(57) ABSTRACT

Systems and methods hybrid spatial audio in accordance with embodiments of the invention are illustrated. One embodiment includes a hybrid spatial audio rendering system, including at least one headphone, at least one loudspeaker, and a control device, including a processor, and a memory, the memory containing a hybrid spatial audio rendering application that configures the processor to obtain an audio stream, generate, based on the audio stream, an audio channel for each transducer of the at least one headphone and for each of the at least one loudspeaker, and play back the generated audio channels using the associated transducer and loudspeaker such that an expanded spatial audio soundstage is rendered from the perspective of a wearer of each of the at least one headphone.

### CROSS-REFERENCE TO RELATED APPLICATIONS

The current application claims priority under 35 U.S.C. 119(e) to U.S. Provisional Patent Application Ser. No. 63/488,453, entitled “Systems and Methods for Hybrid Spatial Audio”, filed Mar. 3, 2023. The disclosure of U.S. Provisional Patent Application Ser. No. 63/488,453 is hereby incorporated herein by reference in its entirety for all purposes.

### FIELD OF THE INVENTION

The present invention generally relates to spatial sound reproduction using headphones and loudspeakers.

### BACKGROUND

Monophonic sound (or “mono”) refers to audio content that is delivered over a single channel of audio. It is typically reproduced over a single loudspeaker (or “speaker”). In contrast, stereophonic sound (or “stereo”) refers to audio content that is delivered over two separate audio channels and is typically reproduced from two loudspeakers on the left and right side in front of the listener.

Surround sound is a broad term used to describe audio content that is delivered over more than two audio channels. These channels can typically be divided into at least a set of front channels and a set of side and/or rear channels. Higher channel formats may have additional divisions. Surround sound systems are generally described using the format A.B, or A.B.C, where A is the number of loudspeakers at the listener's height (the listening plane), B is the number of subwoofers, and C is the number of overhead loudspeakers. For example, a 5.1 surround sound system has 6 audio channels, where 5 are allocated to the listening plane loudspeakers, and 1 is allocated to the subwoofer (which may or may not be at the listening plane). As an additional example, 7.1.4 surround sound such as that found in Dolby Atmos audio systems allocates 7 channels to listening plane loudspeakers, 1 channel to a subwoofer, and 4 channels to overhead loudspeakers.

When a user is wearing headphones, i.e. one transducer directly positioned over each ear or at the entrance of the ear canal opening, the experience of surround sound can be emulated using only the two headphone transducers by playing back a binaural version of the original mono, stereo, or multichannel content. For the avoidance of doubt, herein “loudspeaker” refers to speakers that are not part of headphones. Further, “headphones” refers to any hardware device that places one or more transducers directly at the user's ear, and is not restricted to headband configurations. “Earbud” or in-ear headphones are also contemplated within the class of “headphones”.

The human hearing process is based on the analysis of acoustic signals that arrive at the two ears for differences in intensity, time of arrival, and directional filtering by the outer ear (pinna). Head-related transfer functions (HRTFs) are responses that characterize how an ear receives sound from a point in space. HRTFs are typically collected using a dummy head (or actual human head) with microphones in each ear in order to fully capture the filtering that occurs as sound arrives from different directions and is shaped by the ear. A binaural version of the original content can then be created by filtering the signal in each audio channel with the left and right ear HRTFs of the corresponding loudspeaker.

### SUMMARY OF THE INVENTION

Systems and methods hybrid spatial audio in accordance with embodiments of the invention are illustrated. One embodiment includes a hybrid spatial audio rendering system, including at least one headphone, at least one loudspeaker, and a control device, including a processor, and a memory, the memory containing a hybrid spatial audio rendering application that configures the processor to obtain an audio stream, generate, based on the audio stream, an audio channel for each transducer of the at least one headphone and for each of the at least one loudspeaker, and play back the generated audio channels using the associated transducer and loudspeaker such that an expanded spatial audio soundstage is rendered from the perspective of a wearer of each of the at least one headphone.

In a further embodiment, to generate an audio channel for each transducer of the at least one headphone, the hybrid spatial audio rendering application further configures the processor to process the audio with at least one head-related transfer function.

In still another embodiment, the method further includes steps for a tracking device, where the tracking device is configured to track the position and orientation of the at least one headphone with respect to a reference point within a common coordinate plane with the at least one loudspeaker.

In a still further embodiment, the hybrid spatial audio rendering application further configures the processor to modify the generated audio channels based on the tracked position and orientation of the at least one headphone such that the expanded spatial audio sound stage remains spatially locked to the reference point regardless of an orientation and a position of the at least one headphone.

In yet another embodiment, the tracking device is incorporated into a virtual or augmented reality headset.

In a yet further embodiment, the tracking device is incorporated into a portable computing device such as a mobile phone or tablet.

In another additional embodiment, the hybrid spatial audio rendering application further configures the processor to move the location of spatial audio objects in the expanded spatial audio sound stage.

In yet another additional embodiment, a method for rendering spatial audio, includes obtaining an audio stream, generating, based on the audio stream, an audio channel for each transducer of a headphone and for each transducer of at least one loudspeaker, and play back the generated audio channels using the associated transducer and loudspeaker such that an expanded spatial audio soundstage is rendered from the perspective of a wearer of each of the at least one headphone.

In a further additional embodiment, the method further includes generating an audio channel for each transducer of the at least one headphone includes processing the audio with at least one head-related transfer function.

In another embodiment again, the method further includes steps for tracking the position and orientation of the at least one headphone with respect to a reference point within a common coordinate plane with the at least one loudspeaker using a tracking device.

In a further embodiment again, the method further includes steps for modifying the generated audio channels based on the tracked position and orientation of the at least one headphone such that the expanded spatial audio sound stage remains spatially locked to the reference point regardless of an orientation and a position of the at least one headphone.

In still yet another embodiment, the tracking device is incorporated into a virtual or augmented reality headset.

In a still yet further embodiment, the tracking device is incorporated into a portable computing device such as a mobile phone or tablet.

In still another additional embodiment, the method further includes steps for moving the location of spatial audio objects in the expanded spatial audio sound stage.

In yet another additional embodiment again, a spatial audio system includes a headphone includes a left transducer and a right transducer, a plurality of loudspeakers, a processor, and a memory, the memory containing a hybrid spatial audio rendering application that configures the processor to obtain an audio track, generate a binaural version of the audio track using head-related transfer functions, play back the binaural audio channels the headphone, and play back the audio track using the plurality of loudspeakers such that an expanded spatial audio soundstage is rendered from the perspective of a wearer of each of the at least one headphone.

In a still further additional embodiment, to generate the binaural version of the audio track, the hybrid spatial audio rendering application further directs the processor to apply a head-related transfer function for a left ear to the audio track to produce a left channel, and apply a head-related transfer function for a right ear to the audio track to produce a right channel.

In still another embodiment again, the headphone is integrated into a virtual reality headset.

In a still further embodiment again, the headphone is a set of earbuds.

In yet another additional embodiment, the plurality of loudspeakers includes a subwoofer, where bass frequencies in the audio track are played back only via the subwoofer.

In a yet further additional embodiment, the headphone is open-backed.

In yet another embodiment again, the method further includes steps for a second headphone.

Additional embodiments and features are set forth in part in the description that follows, and in part will become apparent to those skilled in the art upon examination of the specification or may be learned by the practice of the invention. A further understanding of the nature and advantages of the present invention may be realized by reference to the remaining portions of the specification and the drawings, which forms a part of this disclosure.

### BRIEF DESCRIPTION OF THE DRAWINGS

The description and claims will be more fully understood with reference to the following figures and data graphs, which are presented as exemplary embodiments of the invention and should not be construed as a complete recitation of the scope of the invention.

FIG. 1 illustrates a hybrid spatial audio rendering system having one loudspeaker in accordance with an embodiment of the invention.

FIG. 2 illustrates a hybrid spatial audio rendering system having two loudspeakers in accordance with an embodiment of the invention.

FIG. 3 illustrates a hybrid spatial audio rendering system having Three loudspeakers in accordance with an embodiment of the invention.

FIG. 4 illustrates a hybrid spatial audio rendering system having a soundbar in accordance with an embodiment of the invention.

FIG. 5 illustrates a hybrid spatial audio rendering system having spatial audio loudspeakers in accordance with an embodiment of the invention.

FIG. 6 is a block diagram for a control device in accordance with an embodiment of the invention.

FIG. 7 is a flow chart for a hybrid spatial audio rendering process in accordance with an embodiment of the invention.

### DETAILED DESCRIPTION

While humans have only two ears, they are able to locate sounds in three dimensions. While time or intensity differences in received sound in the ear provide source direction information in the horizontal (azimuthal) plane, in the median plane, time and level differences are generally the same. For example, a sound source directly in front of the listener will produce sound of equal level that arrives at both ears simultaneously. The same is true for a sound source directly behind the listener. And yet, humans are able to discriminate front sounds from back sounds.

This is because sound localization is based on spectral (frequency response) filtering. The reflection and diffraction of sound waves from the head, torso, shoulders, and pinnae, combined with resonances caused by the ear canal, form the physical basis for the Head-Related Transfer Function (HRTF).

HRTF-based processing of audio signals has typically been the main method for rendering spatial audio over headphones. By filtering a source signal with the HRTF filters corresponding to source to left- and right-ear transfer functions for a given source angle, it is theoretically possible to produce the needed binaural signals that give the impression of a virtual sound source (at that angle) when listening over headphones. In practice, however, because the magnitude and phase of these head-related transfer functions vary significantly from person to person, it has been difficult to achieve realistic spatial audio rendering for every listener.

One of the greatest challenges in spatial audio is to render virtual sound sources that are perceived out in the front hemisphere of a listener. Vision plays an important role in perception and, in many cases, overwhelms hearing. When a virtual sound source presented at a desired front hemisphere location is not accompanied by a corresponding visual image, the human brain is “wired” to assume that the source must be from the back. This causes a phenomenon called “front-back confusion”. Even when the HRTF filters used to create the front virtual source are based on individual measurements of a listener's ears, this problem often persists. While some of the left-right directionality is preserved, listeners hear sources inside their head and not out in front.

Localization of sound sources in the front is not a problem when using loudspeakers. A sound source originating from a loudspeaker will be perceived to be coming from that distance and direction, regardless of the position of the listener in the room. However, loudspeakers are not always a practical option for spatial audio because of their size and the number required to render all the desired directions. Virtual sound sources in the back hemisphere can be rendered very accurately over headphones by processing the left and right ear signals with the appropriate HRTF. The lack of visual cues is no longer an issue and the fact that human hearing spatial resolution is coarser in the back makes this rendering more robust to variations in the HRTF filters that may arise because of differences in ear shapes.

With advances in surround sound and virtual/augmented reality, there is a need to create a system that can render sound sources in the correct spatial location for every listener. Systems and methods described herein are able to “expand” the sound stage out from inside a headphone user's head, greatly enhancing the listening experience and creating a more accurate surround sound. In many embodiments, a hybrid sound stage is created by rendering audio simultaneously from headphones and loudspeakers (“speakers”). One or more loudspeakers can be used depending on their configuration to enhance a headphone listening experience by providing playback of specific channels. In various embodiments, headphones for use with the system are open-backed, however similar results can be achieved with closed-backed headphones or in-ear loudspeakers. In some embodiments, the headphones are bone-conduction audio devices which do not occlude the ears. Most modern audio content comes with two or more channels. Various “mixing” methods can be used to upmix to a higher number of channels, or downmix to a lower number of channels. An example upmixing method can be found in U.S. application Ser. No. 17/300,939 titled “Systems and Methods for Audio Upmixing”, filed Dec. 15, 2021, the entirety of which is hereby incorporated by reference. As can readily be appreciated, input audio can be mixed to produce an appropriate number of channels for the available number of loudspeakers if desired.

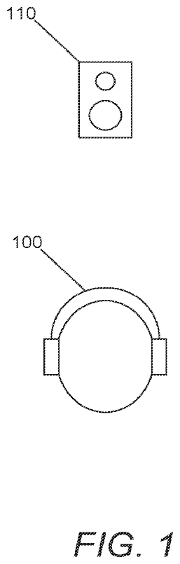

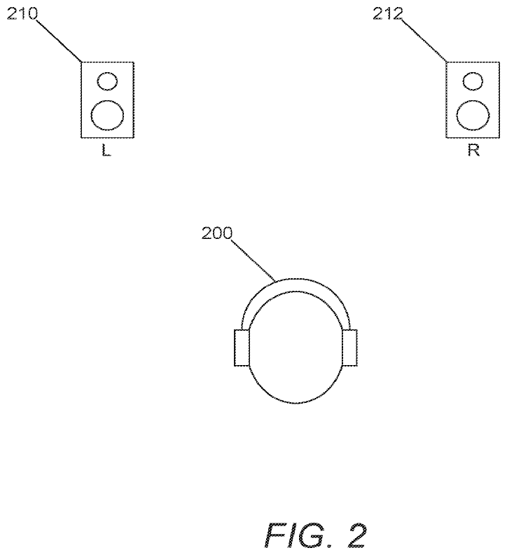

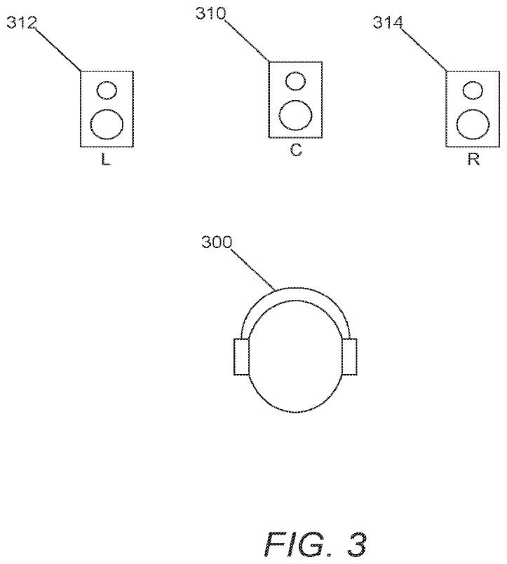

Turning now to the drawings, FIG. 1 illustrates a system for hybrid spatial audio rendering in accordance with an embodiment of the invention. Headphones 100 provide a first set of audio signals to the user, where the loudspeaker 110 provides a second set of audio signals. In many embodiments, the front audio channels are played via the loudspeaker, and the side, rear, and height channels are rendered using HRTF filtering and delivered via the headphones. FIG. 2 illustrates a similar system in accordance with an embodiment of the invention having two loudspeakers: a left loudspeaker 210 and a left loudspeaker 212; along with a pair of headphones 200. FIG. 3 illustrates yet another similar system in accordance with an embodiment of the invention having three loudspeakers: a center loudspeaker 310, a left loudspeaker 312, and a right loudspeaker 314; along with headphones 300. As can readily be appreciated, loudspeakers may be part of a larger surround sound system having multiple other loudspeakers. Further, the number of loudspeakers is not limited to 1-3, and may include many more. However, the effect can be realized with as little as one loudspeaker and one pair of headphones.

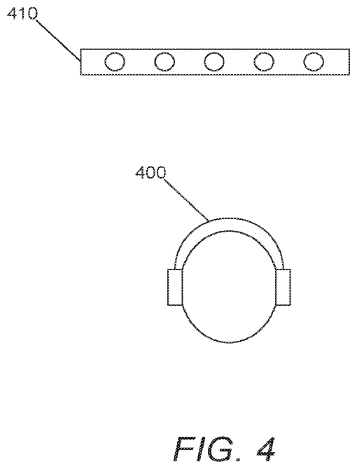

Speakers do not necessarily need to be single channel stand-alone loudspeakers. Turning now to FIG. 4, a hybrid spatial audio rendering system having a sound bar in accordance with an embodiment of the invention is illustrated. The soundbar 410 can be used with similar effect in conjunction with headphones 400. In various embodiments, instead of a soundbar, the loudspeakers of a computer, smart phone, television, and/or any other device can be used as appropriate to the requirements of specific applications of embodiments of the invention. In various embodiments, virtual reality headsets may incorporate a loudspeaker separate from any over-the-ear headphones to function as a loudspeaker as described herein.

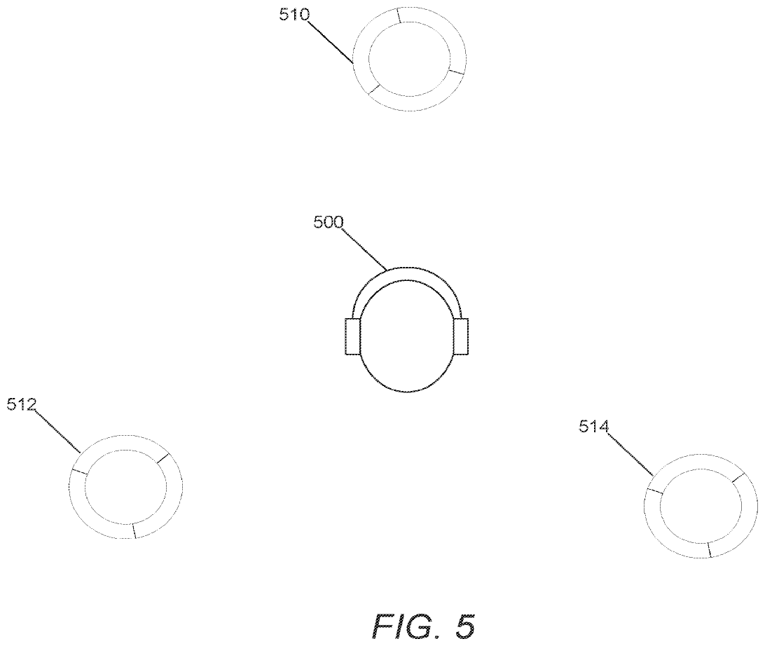

FIG. 5 illustrates a hybrid spatial audio rendering system that uses spatial audio loudspeakers in accordance with an embodiment of the invention. Spatial audio devices 510, 512, and 514 can be used to render audio such that the front channels are synthesized in front of the listener. In numerous embodiments, the spatial audio devices are cells as described in U.S. Pat. No. 11,206,504, titled “Systems and Methods for Spatial Audio Rendering”, issued Dec. 21, 2021, the entirety of which is hereby incorporated by reference. While three spatial audio devices are illustrated in FIG. 5, as can readily be appreciated, any number of spatial audio devices can be used without departing from the scope or spirit of the invention.

In many embodiments, low frequency sound can further be produced by a subwoofer. In some embodiments, low frequency sound can be produced only by the headphones. In various embodiments, whether low frequency sound is produced by the subwoofer or the headphones is optional as to user preference. However, automated switching can be implemented, e.g. moving to headphones from subwoofer during the evening or night to avoid disturbing others. Further, depending on the layout of the loudspeakers in the listening area, channels that can accurately be rendered using the loudspeakers are rendered by them, and the remainder of the channels are rendered by the headphones.

In numerous embodiments, audio signals directed to the loudspeakers can be equalized to remove frequency response changes that are caused by the physical structure of the headphones on the listener's ears. In various embodiments, a tracking device can be incorporated (e.g. ultra-wideband, accelerometers, camera-based, etc.) that are used to obtain listener head position and/or orientation in order to continuously adjust the HRTF filters to preserve the spatial location of virtual loudspeakers simulated by the HRTFs with respect to the real loudspeakers as the listener moves. In various embodiments, the listener can manually select various real and/or virtual loudspeakers to be used, and control the placement of virtual loudspeakers. In numerous embodiments, the listener may selectively move a sound source via an interface using spatialization shaders. Spatialization shaders are discussed in further detail in U.S. Prov. App. No. 63/264,089, titled “Systems and Methods for Rendering Spatial Audio Using Spatialization Shaders”, filed Nov. 15, 2021, the entirety of which is hereby incorporated by reference.

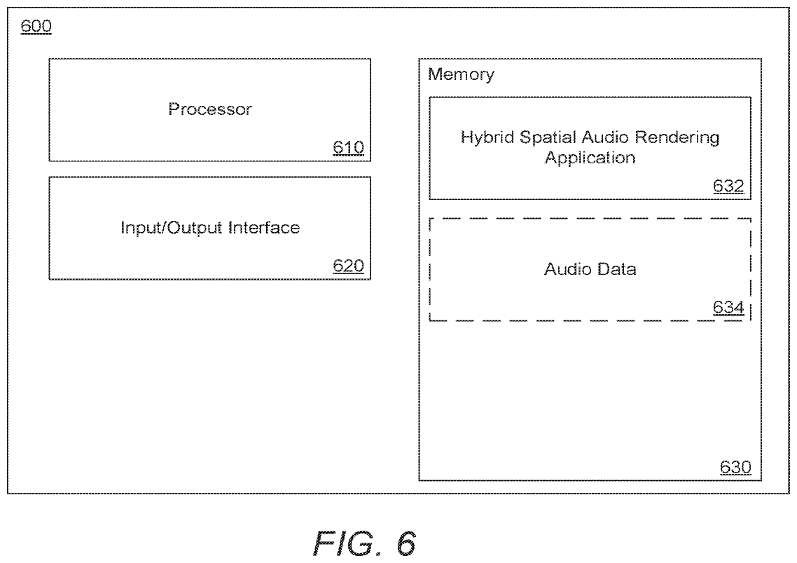

In many embodiments, hybrid spatial audio rendering systems incorporate a control device which coordinates playback across any loudspeakers and the headphones. The control device can be any computing device such as, but not limited to, a smart phone, a smart loudspeaker (e.g. a cell), a personal computer, a server, a smart television, a game console, a virtual reality headset, and/or any other computing device as appropriate to the requirements of specific applications of embodiments of the invention. Turning now to FIG. 6, a block diagram for a control device in accordance with an embodiment of the invention is illustrated. Control device 600 includes a processor 610. In numerous embodiments, more than one processor is used, and/or a combination of processors and coprocessors. In numerous embodiments, the processor is a central processing unit (CPU), a graphics processing unit (GPU), an application specific integrated circuit (ASIC), field-programmable gate-array (FPGA), and/or any other logic circuit as appropriate to the requirements of specific applications of embodiments of the invention. The control device 600 further includes an input/output (I/O) interface 620. I/O interfaces can be any component that enables communication between the control device, connected loudspeakers, headphones, audio sources (e.g. servers providing an audio stream or file), and/or any other device as appropriate to the requirements of specific applications of embodiments of the invention. In many embodiments, the I/O interface includes one or more transceivers, receivers, transmitters, or wired ports as appropriate to the requirements of specific applications of embodiments of the invention. As can be readily appreciated, any component of the system can be connected via a wired and/or wireless connection depending on construction.

The control device 600 further includes a memory 630. The memory can be implemented using volatile memory, nonvolatile memory, or any combination thereof. The memory contains a hybrid spatial audio rendering application 632 which can configure the processor to perform various hybrid spatial audio rendering processes as described herein. For example, computing HRTFs and providing the appropriate audio channels to the appropriate loudspeaker/headphone, listener tracking, audio selection, providing graphical user interfaces, and/or any other process as appropriate to the requirements of specific applications of embodiments of the invention. The memory 630 may also store audio data 634 at various points which contains the audio to be played back.

In many embodiments, smart phones are used as control devices and/or as an audio source for the system. However, many smart phones do not allow 3^{rd} parties to process streaming audio from music services on the phone, and instead only allow processing of files that are stored locally on the device. In order to allow processing of 3^{rd} party audio streams on the phone, the audio stream can be transmitted to a loudspeaker which in turn can stream to the headphones. The spatial audio processing can then take place on the loudspeaker.

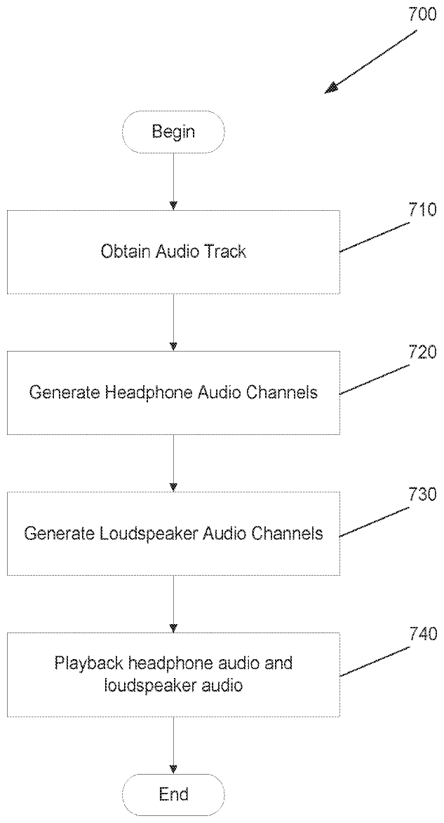

Turning now to FIG. 7, a process for rendering hybrid spatial audio in accordance with an embodiment of the invention is illustrated. Process 700 includes obtaining (710) an audio track to be rendered. In numerous embodiments, the audio track is streamed instead of obtained as a single track. Channels for the headphone transducers and loudspeaker transducers are generated, respectively (720,730). In numerous embodiments, the headphone channels are generated such that they form a binaural representation of the audio track. In various embodiments, the headphone and loudspeaker channels are rendered such that together they create spatial audio. In some embodiments, the headphone channels are generated HRTFs to position sound objects in the sound stage relative to the listener, and the loudspeaker channels are generated to produce the same sound objects at the same position in the sound stage using a tracked location of the listener. In various embodiments, bass components are generated primarily (or only) using subwoofers in the set of loudspeakers. In a number of embodiments, ambient components of the audio track are generated primarily (or only) using the loudspeakers while direct components are generated primarily (or only) using the headphones.

Although specific systems and methods for hybrid spatial audio rendering are discussed above, many different methods can be implemented in accordance with many different embodiments of the invention. It is therefore to be understood that the present invention may be practiced in ways other than specifically described, without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. A hybrid spatial audio rendering system, comprising:
at least one headphone;
at least one loudspeaker; and
a control device, comprising:
a processor; and
a memory, the memory containing a hybrid spatial audio rendering application that configures the processor to:
obtain an audio stream;
generate, based on the audio stream, an audio channel for each transducer of the at least one headphone and for each of the at least one loudspeaker; and
play back the generated audio channels using the associated transducer and loudspeaker such that an expanded spatial audio soundstage is rendered from the perspective of a wearer of each of the at least one headphone.

2. The hybrid spatial audio rendering system of claim 1, wherein to generate an audio channel for each transducer of the at least one headphone, the hybrid spatial audio rendering application further configures the processor to process the audio with at least one head-related transfer function.

3. The hybrid spatial audio rendering system of claim 1, further comprising a tracking device, where the tracking device is configured to track the position and orientation of the at least one headphone with respect to a reference point within a common coordinate plane with the at least one loudspeaker.

4. The hybrid spatial audio rendering system of claim 3, wherein the hybrid spatial audio rendering application further configures the processor to modify the generated audio channels based on the tracked position and orientation of the at least one headphone such that the expanded spatial audio sound stage remains spatially locked to the reference point regardless of an orientation and a position of the at least one headphone.

5. The hybrid spatial audio rendering system of claim 3, wherein the tracking device is incorporated into a virtual or augmented reality headset.

6. The hybrid spatial audio rendering system of claim 3, wherein the tracking device is incorporated into a portable computing device such as a mobile phone or tablet.

7. The hybrid spatial audio rendering system of claim 1, wherein the hybrid spatial audio rendering application further configures the processor to move the location of spatial audio objects in the expanded spatial audio sound stage.

8. A method for rendering spatial audio, comprising:
obtaining an audio stream;
generating, based on the audio stream, an audio channel for each transducer of a headphone and for each transducer of at least one loudspeaker; and
play back the generated audio channels using the associated transducer and loudspeaker such that an expanded spatial audio soundstage is rendered from the perspective of a wearer of each of the at least one headphone.

9. The method for rendering spatial audio of claim 8, wherein generating an audio channel for each transducer of the at least one headphone comprises processing the audio with at least one head-related transfer function.

10. The method for rendering spatial audio of claim 8, further comprising tracking the position and orientation of the at least one headphone with respect to a reference point within a common coordinate plane with the at least one loudspeaker using a tracking device.

11. The method for rendering spatial audio of claim 10, further comprising modifying the generated audio channels based on the tracked position and orientation of the at least one headphone such that the expanded spatial audio sound stage remains spatially locked to the reference point regardless of an orientation and a position of the at least one headphone.

12. The method for rendering spatial audio of claim 10, wherein the tracking device is incorporated into a virtual or augmented reality headset.

13. The method for rendering spatial audio of claim 10, wherein the tracking device is incorporated into a portable computing device such as a mobile phone or tablet.

14. The method for rendering spatial audio of claim 8, further comprising moving the location of spatial audio objects in the expanded spatial audio sound stage.

15. A spatial audio system, comprising:
a headphone comprising a left transducer and a right transducer;
a plurality of loudspeakers;
a processor; and
a memory, the memory containing a hybrid spatial audio rendering application that configures the processor to:
obtain an audio track;
generate a binaural version of the audio track using head-related transfer functions;
play back the binaural audio channels the headphone; and
play back the audio track using the plurality of loudspeakers such that an expanded spatial audio soundstage is rendered from the perspective of a wearer of each of the at least one headphone.

16. The system of claim 15, wherein to generate the binaural version of the audio track, the hybrid spatial audio rendering application further directs the processor to:
apply a head-related transfer function for a left ear to the audio track to produce a left channel; and
apply a head-related transfer function for a right ear to the audio track to produce a right channel.

16. The system of claim 15, wherein the headphone is integrated into a virtual reality headset.

17. The system of claim 15, wherein the headphone is a set of earbuds.

18. The system of claim 15, wherein the plurality of loudspeakers comprises a subwoofer, where bass frequencies in the audio track are played back only via the subwoofer.

19. The system of claim 15, wherein the headphone is open-backed.

20. The system of claim 15, further comprising a second headphone.
